(19) United States
(12) Patent Application Publication
(10) Pub. No.: US 2007/0227368 A1
(43) Pub. Date: Oct. 4, 2007

(54) Demolding Apparatus and Method Utilizing Resonant Frequencies

(76) Inventors: Mitchell Lapman, Elizabethtown, PA (US); Denny Ng, Hackettstown, NJ (US); Steve Ford, Oak Park, IL (US); Tom Johnson, St. Charles, IL (US); Diane Humphries, Lexington, SC (US)

Correspondence Address: FITZPATRICK CELLA HARPER & SCINTO, 30 ROCKEFELLER PLAZA, NEW YORK, NY, 10112, US

(21) Appl. No.: 11/629,916

(22) PCT Filed: Jun. 17, 2005
(86) PCT No.: PCT/US05/21387

§ 371 Date: Apr. 17, 2007

Related U.S. Application Data
(60) Provisional application No. 60/580,832, filed on Jun. 18, 2004.

(51) Int. Cl. A23G 3/02; A23G 1/04; A23L 1/025; G01N 33/00

(52) U.S. Cl. 99/451; 426/231; 426/389; 426/515; 99/485

(57) ABSTRACT

Apparatuses and methods are described for demolding articles from molding trays, including confectionery articles such as molded chocolate pieces, utilizing the resonant frequency of the mold tray. The methods may also be used to improve the distribution of edible liquid starting material deposited in mold tray cavities utilizing the resonant frequency of the mold tray. The invention is also directed to a process for controlling molding and demolding processes, such as by determining an empty state of a demolded mold tray according to its characteristic resonant frequency.

### BACKGROUND OF THE INVENTION

1. Field of the Invention

The invention is directed to apparatuses and methods for demolding articles from molding trays, including without limitation, confectionery articles, such as molded chocolate pieces utilizing the resonant frequency of the mold tray. The invention is also directed to a method for distributing edible liquid starting material in mold tray cavities utilizing the resonant frequency of the mold tray. The invention is also directed to a process for controlling molding and demolding processes, such as by determining an empty state of a demolded mold tray according to its characteristic resonant frequency.

2. Description of the Prior Art

Conventional confectionery molding lines produce molded confectionery pieces by depositing liquid edible starting material into plastic mold trays, cooling the starting material until it is solidified, and then removing the solidified pieces from the mold trays. The trays may be inverted over a conveyor surface, so that the demolded pieces can be distributed to packaging machines. Conventional demolding apparatuses incorporating these features are described, for example, in Bernard W. Minifie, Chocolate, cocoa, and confectionery, Avi Publishing Company Inc., Westport Connecticut (1980), which is incorporated by reference.

In a conventional continuous molding/demolding line, depicted in FIG. 1, a mold tray is first detected at 210. This usually involves visually inspecting the mold tray to determine whether it is empty. Alternatively, weight measurements or vision sensors could be used to determine that the mold tray is in place and whether the mold cavities in the mold tray are completely empty. Partially filled molds must be rejected at D, involving additional expense in terms of labor and equipment. Empty molds C are forwarded to mold conditioning stage 220. In the example of a process for molding chocolate pieces, this involves bringing the mold tray to a particular temperature and may also involve preparing the surface condition of the mold. Liquid fill material E, such as chocolate, is deposited at depositing station 230 and the filled mold trays A are thereafter forwarded to cooling section 240 and demolding section 250. If a mold tray continues through the line partially filled, the depositor may nevertheless deposit the predetermined quantity of fill material in each cavity, overfilling the filled cavity, depositing material onto other molded pieces, onto the mold tray and onto other pieces of equipment. Even if a filled cavity in a partially filled mold tray is correctly identified by a vision system or the like, there is a loss of efficiency associated with carrying the partially filled tray through the system.

It can be difficult to demold pieces from a mold tray because of the adhesion between the molded pieces and the tray, which may be caused by surface tension, the formation of a vacuum, or other factors. To facilitate the removal of the solidified pieces from the mold tray, the mold tray may be flexed, hammered or vibrated. However, using the current technology, molded pieces often remain in the mold after demolding, particularly when the pieces are small molded confectionery pieces. This, in turn, requires the addition of personnel and equipment to remove the partially demolded mold trays from the line and replace them with new ones. The partially demolded trays must also be cleaned, which consumes additional resources.

Specific steps in the demolding process according to the prior art are shown in FIG. 2. Inverter 110 flips the mold trays over on a conveyor belt and urges molded pieces out of the mold by application of a gravitational force. The demolding method and apparatus according to the invention may be used with a mold tray inverter, but the invention is not limited to this mode of removing molded pieces from the mold tray.

Additional means of removing difficult-to-remove molded pieces from the mold tray include mold twister 120, which imparts a twisting or flexing motion to the tray to loosen molded pieces from the mold, hammer-blow station 130, which delivers hammer blows to the mold tray, and vibration unit 140 which applies vibration to the tray. Demolded pieces are shown taken away at B. The above described additional means for removing chocolate pieces stuck in a mold tray may be used with the methods and apparatuses of the present invention, although the invention is intended to reduce or eliminate the need to use such additional means for removing chocolate pieces, which are labor and equipment intensive and unsuitable for feedback control.

Conventionally, the entire demolding process (at least insofar as demolding of molded edible pieces is concerned) is an open loop process: there are no feedback controllers used. Generally, improved demolding has been pursued by increasing the force applied to the mold trays, such as by striking or vibrating the molds more aggressively. This is not the most desirable method, as it may cause damage to the molded pieces and the mold trays themselves. Thus, there continues to be a need in the art for a molding and/or demolding apparatus that can be more accurately controlled and that will more efficiently remove molded pieces from a mold tray. Edible molded food products cannot generally be removed from molds using grabbing means, due to the relatively delicate nature of the products and the desire not to see them deformed. Thus, the need for efficient molding and/or demolding with effective feedback control is particularly acute in the field of molding and/or demolding molded edible products, and the presently described closed loop feedback system represents an advancement in the art.

### SUMMARY OF THE INVENTION

In one aspect the invention is an apparatus for molding or demolding which uses the resonant frequency of the mold tray to improve demolding. The apparatus includes a mold tray having a plurality of mold cavities and a defined resonant frequency. An energy applicator operatively connected to the mold tray supplies energy to the mold tray at a frequency in a range of about 75 percent to about 125 percent of the resonant frequency of the mold tray.

The resonant frequency of the mold tray may be defined or predetermined off-line by applying an excitation energy to the mold tray at a frequency and measuring a response of the mold tray to the excitation energy at that frequency. This is repeated over a range of frequencies to determine at what frequency a peak response is found. The invention is not limited to one method of measuring a response; measurement of acceleration, stress and/or displacement, for example, may be used to obtain a response. In a preferred embodiment, however, the acceleration of a point on the tray is measured over time by an accelerometer or laser vibrometer. From this data a power spectrum density may be obtained using Fourier transforms or other analytical techniques. The power spectrum density is a quantity that varies with frequency and is at a maximum when the resonant frequency of the mold tray is reached. Thus, the “response” of the mold tray to the excitation energy applied at a frequency is a signal that correlates to the vibration characteristics of the tray (including whether or not resonance has been achieved), and it may be obtained when the tray is empty, when it is full, and when it is partially demolded. The mold tray has a different characteristic resonant frequency when it is full, compared to when it is empty, and the tray has still other resonant frequencies during demolding, when the tray is partially filled. As used herein, the “response” of the mold tray refers to the response to excitation energy obtained at any stage of the molding or demolding process, or obtained when the mold tray is off-line.

Preferably the resonant frequency may be determined for the mold in the filled and in the empty state. In one aspect of the invention, an empty state of the mold tray may be determined by applying an excitation energy to the mold tray at the predetermined resonant frequency of the mold tray, measuring the response in the mold tray as a result of the excitation energy applied at that frequency, and determining if the measured response corresponds to a predetermined peak of the resonant frequency of the mold tray when empty.

In another aspect, the apparatus for demolding according to the invention includes a feedback loop comprising a measurement unit operatively connected to (but preferably not in contact with) the mold tray and also connected to the energy applicator. The response of the mold tray is measured, and a controller modifies the energy applied to the mold tray responsive to a feedback signal from the measurement unit. Generally, at least the frequency of the energy applied is controlled by the controller, but power may also be modulated.

In another aspect, the invention is a demolding process for removing molded pieces from a mold comprising the steps of: vibrating a mold tray at 75 to 125 percent of a resonant frequency of the mold tray; and demolding the molded pieces.

In another embodiment, a method according to the invention is described by the steps of: applying energy to a mold tray at a frequency less than a predetermined resonant frequency of the mold tray when filled; determining the response of the mold tray and generating a corresponding signal; directing the signal to a controller for controlling energy applied to the mold tray; applying energy according to the signal to cause the mold tray to vibrate at or near a resonant frequency of the mold tray; and removing the molded products from the mold tray.

### BRIEF DESCRIPTION OF THE FIGURES

FIG. 1 is a flowchart showing the operations in a conventional continuous molding/demolding line.

FIG. 2 is a flowchart showing the individual demolding operations.

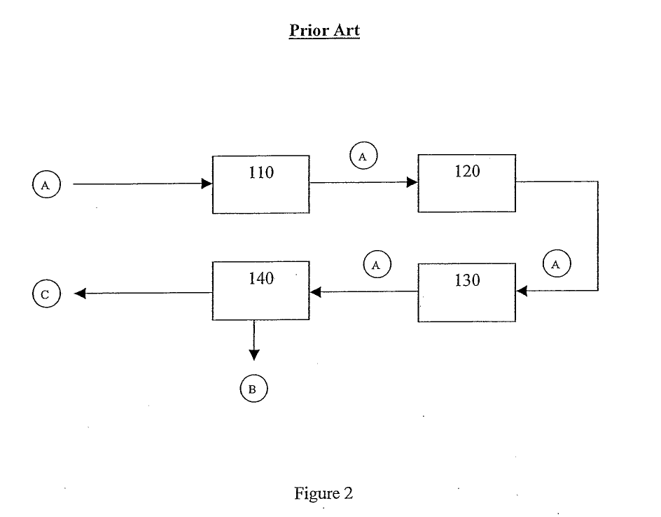

FIG. 3 is an isometric and schematic view of an apparatus according to the invention.

FIG. 4 is a control scheme for a feedback controlled demolding system according to the invention.

### DETAILED DESCRIPTION OF THE PREFERRED EMBODIMENTS

The present invention can be used with any liquid starting material that is deposited into mold cavities in a mold tray and solidified to form molded pieces, including plastics, ceramic, glass and metals. However, the preferred embodiments are described in terms of demolding of molded edible products from mold trays. In particular embodiments, the demolding process is used with fat based edible materials, such as solid molded chocolate, solid molded chocolate pieces having liquid or solid inclusions, molded cheese pieces; or with molded solid sugar pieces, and products conventionally molded in starch molds, including without limitation jelly beans and other jellies and gummies. The Example herein is described in connection with the molding of chocolate pieces. As used herein, chocolate includes standard of identity (SOI) chocolate and non-SOI chocolate.

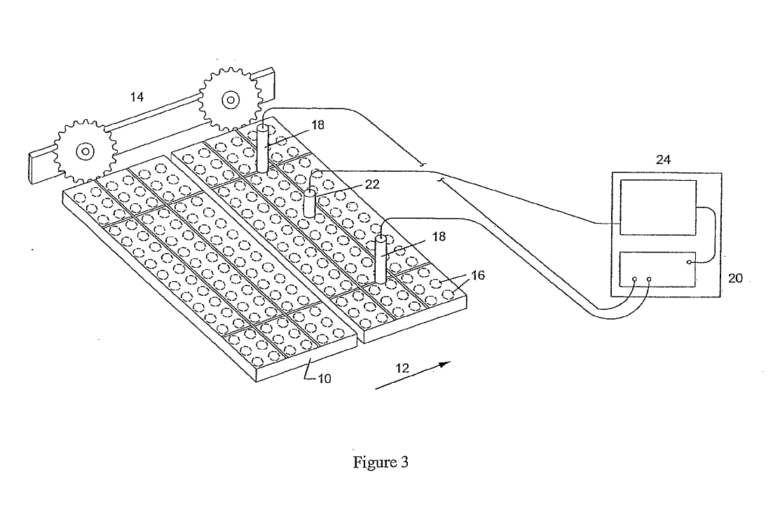

In the preferred embodiment shown in FIG. 3, mold trays 10 are transported continuously or intermittently by conveyor 14 in mold travel direction 12.

The mold trays 10 must have sufficient rigidity that the molded material assumes the desired shape without deformation of the mold. In a production environment, the mold tray must be capable of being transported by means such as conveyors (screw or chains) or manually. Other than these practical considerations, there is no particular limit on the size of the mold tray. Molds as large as 2 meters in their longest dimensions are known in the art. Likewise, mold trays having a longest dimension of 250 mm could be used effectively with the invention. Mold trays used in connection with the present invention are usually open trays, which are emptied by inverting them.

The materials of construction are not particularly limited, and may include metal, plastic, including polycarbonate, or silicone rubber. In the context of molding edible pieces, of course, the materials of construction must be food grade.

The mold tray has a resonant frequency (either filled or empty) generally in a range of about 100 Hz to about 500 Hz. A resonant frequency is a natural frequency of vibration determined by the physical parameters of the vibrating object, such as its mass and elasticity. While a vibrating object may have multiple resonant frequencies, as used herein, “resonant frequency” means that frequency, which when excited, results in the greatest amplitude of vibration. As a general principle of physics it takes less energy to vibrate an object at its resonant frequency. The resonant frequency may be determined by correlating the frequency with a maximum in the power density spectrum (PDS). The PDS is obtained by measuring the acceleration of a point on the tray over time and applying analytical techniques.

In the context of the present invention, the mold tray 10 has a characteristic resonant frequency, which increases during the course of the demolding process as pieces fall out of the mold tray. The resonant frequency is determined by many factors including without limitation the weight, rigidity, number of cavities, geometry (both of the cavities and the mold), thickness of the mold and molded pieces, and the characteristics of the material being molded. In embodiments, resonant frequencies in a range of about 180 Hz to about 280 Hz have been observed.

A mold tray 10 may have as many cavities 16 as are desired; as few as one and as many as five hundred is practicable. The mold density (defined as number of pieces per unit area) affects the change in the resonant frequency of the mold as it is emptied.

In order to vibrate the molding tray at or near its resonant frequency it is required to have an energy applicator 18, a transducer for converting an electrical signal into energy at a specific frequency, such as an acoustic horn. An “energy applicator,” is a device that transmits energy to the mold tray to make the tray resonate. Generally, the energy applicator causes displacement of a mold tray or a portion of a mold tray in a periodic manner so that the tray vibrates. Such periodic displacement may be created acoustically, mechanically or by as yet unforeseen modes of imparting vibratory motion. The resulting vibration may be complex, such as combined with flexing and/or twisting motion of the tray, or simple, such that the entire tray oscillates. A critical aspect of the energy applicator is that it must be capable of delivering energy to the mold tray at or near its resonant frequency. Preferably, the energy applicator is capable of applying energy at a plurality of frequencies, to accommodate variations in the resonant frequency of the mold tray during demolding and to accommodate different mold trays having different resonant frequencies.

Suitable energy applicators include acoustical, mechanical or electromechanical devices (or combinations thereof) whose frequency can be modulated in the specified range, including acoustic generators, pneumatic hammers or electrically controlled actuators or servomotors. The placement of the applicator is not particularly limited. For example, an acoustic generator could be placed above or below a filled tray, or before or at a demolding station where molded pieces are removed from a mold tray 10. In general, the applicator should be sufficiently close to the mold tray to efficiently deliver energy to cause the tray to resonate.

“Excitation energy” is defined as energy applied at a frequency to a mold, whether applied off-line or on-line. The energy applicator is adapted to increase or decrease the frequency of the excitation energy applied. In a preferred embodiment, energy is applied at increasing frequency until the mold tray is made to resonate. This is typically done at constant power (because the resonant frequency is defined as the frequency at which maximum vibration of the tray is obtained at a minimum input energy), or power may be modulated, depending upon the application. Likewise, the energy applicator may be applied in bursts according to a predetermined scheme, or continuously. Reasonable results may be achieved even where the frequency of the excitation energy is not at the resonant frequency of the mold tray but only near it. Thus, the mold trays may be excited at 75 percent to 125 percent of the resonant frequency. The controller may be adapted to apply excitation energy in a narrower range of about 80 percent to about 120 percent of the resonant frequency, or in a range of about 90 percent to about 110 percent of the resonant frequency.

Conventional vibrators used with demolding equipment do not operate at the resonant frequencies of conventional mold trays, and are not capable of operating in the ranges described herein. Conventional mechanical vibrators used in current demolding equipment have an operating frequency of up to 100 Hz. In a context outside of the demolding context, mechanical devices having higher frequencies are known. Acoustic generators have a frequency range in the entire audible range. Generally, in accordance with the invention, a frequency in a range of about 100 Hz to about 500 Hz may be used. In preferred embodiments, the energy applicator according to the invention is capable of delivering energy to the mold tray at a frequency in a range of about 120 Hz to about 360 Hz, preferably about 140 Hz to about 360 Hz, more preferably about 160 Hz to about 360 Hz, and most preferably in a range of about 200 Hz to about 360 Hz.

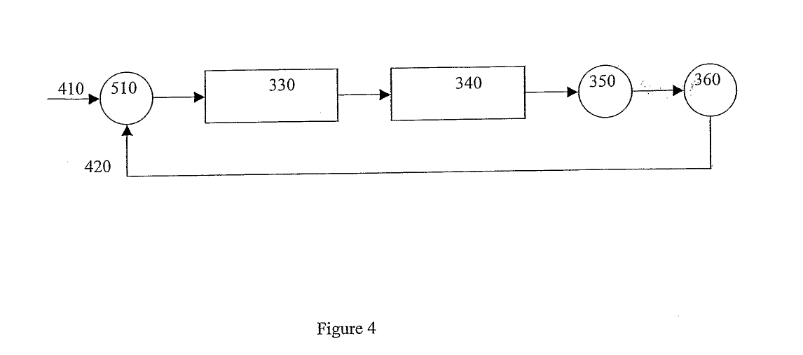

The controller 20 is a device such as a programmable logic controller or other computing device that will take the feedback from the measurement element 22 and its processor 24 and vary the energy applied by the applicator 18 as required to maintain a desired response in the mold tray. The key aspect of the controller is that it is capable of maintaining a resonant frequency or a frequency near resonant over the range of frequencies needed to complete the demolding. An appropriate control scheme can be adopted for controlling the application of energy to the tray, as shown in FIG. 4. Response 420 from the tray (typically a power spectrum density) is compared at 510 with a response set point 410. Controller signal 330 is forwarded to signal generator 340, and energy at the appropriate frequency is applied to the mold tray at 350. Measurement block 360 includes the functions of measuring the acceleration of a point on the mold tray over time with measuring element 22, and calculating a corresponding power spectrum density to provide the response 420, using the appropriate processor 24 associated with the measuring element 22. As used herein, “measurement unit” means both the measurement element 22 (such as a laser vibrometer) and processor 24, that are required to produce a signal corresponding to the response of the mold tray to the excitation energy, which is directed to the controller.

The measurement unit 22/24 for determining the response of the mold tray is required to determine whether the mold tray has reached its resonant frequency. In general (especially when the tray is moving in a continuous conveyor system), it is preferred that the measurement unit not be in contact with the mold tray. In a preferred system, a laser vibrometer is used, such as is commercially available from Polytec, Inc., Auburn, Mass. Otherwise, a conventional accelerometer or force transducer may be used on the tray to produce a feedback signal corresponding to the amplitude of displacement, or a displacement sensor, such as a Keyence Lx2 optical micrometer, available from Keyence America, Woodcliff Lake, N.J. The critical feature of the measurement device is that it produces a signal that is significantly differentiated at resonance as compared to the signal produced when the mold is not resonating.

The measurement unit can detect a characteristic resonance signature for an empty tray that may be used to forward a signal to the controller to turn off the energy applicator after the demolding process is completed. Empty trays of the identical design should have a substantially similar characteristic resonance signature. Thus the predetermined resonant frequency may be determined off-line, using a similar tray.

Generally, it is desirable to minimize any deleterious effects that creating resonant frequencies in the mold trays may have on surrounding machinery and personnel. In the first instance, it may be possible to select frequencies that do not resonate other pieces of equipment. The mold itself can be designed to resonate at a frequency significantly different than the other piece of equipment, or the effects of vibrations can be damped or isolated.

To minimize the noise of generating acoustic energy, two ultrasonic generators operating at frequencies well above the audible range and well above the resonant frequency of the mold tray may yet produce a beat frequency in the mold tray when combined such that resonance in the mold tray is achieved. A plurality of mechanical applicators at lower frequencies could be combined to achieve this effect.

Removing molded pieces of chocolate from a mold tray is usually accomplished by inverting the tray as described. However it may still be necessary to employ additional means for removing the pieces from the trays, including striking the trays with a hammer blow, or flexing the tray.

Before practicing the methods of the invention, it is preferable, but not necessary, to obtain a predetermined resonant frequency of the tray. The resonant frequency is obtained by exciting the tray at a number of different frequencies and measuring the response, typically expressed as power spectrum density. The resonant frequency of an object is that frequency which, when the object is excited, yields the maximum response. As noted above, in preferred embodiments, the mold trays may have resonant frequencies between about 150 Hz and about 300 Hz, from about 170 Hz to about 300 Hz or in a range of about 190 Hz to about 300 Hz.

In a first step of the method according to the invention, the mold tray is excited with the energy applicator at a given frequency, less than the predetermined resonant frequency of a filled mold tray. This determination may be made utilizing a like tray and like equipment, or otherwise estimated. In preferred embodiments, the frequency applied in this first step is about 75 percent to less than about 100 percent, and preferably about 75 percent to about 80 percent of the resonant frequency, and in embodiments the resonant frequency of the filled mold tray is in a range of about 150 to about 220 Hz, about 170 Hz to about 220 Hz or about 190 Hz to about 220 Hz.

In a second step, the response of the mold tray is determined with a measurement unit, such as an accelerometer or preferably a laser vibrometer. This measurement is processed to provide a signal, which is indicative of the presence or absence of a resonance state achieved in the mold tray. A controller signal is thereafter directed to an energy applicator that alters the frequency of the energy applied, until resonance is achieved. This is typically done by successively increasing the frequency of the energy applied to the mold tray until resonance is detected.

As molded pieces are removed from the mold tray, the resonant frequency of the mold tray increases, due to its decrease in mass and other factors. In preferred embodiments once resonance in the mold tray is initially achieved, energy is thereafter applied at increasing frequencies, in order to maintain resonance in the mold tray during the demolding process. The resonant frequency of the empty tray serves to indicate that the demolding process is complete. In preferred embodiments, the resonant frequency of empty mold trays used in forming chocolate are in a range of about 230 Hz to about 300 Hz.

The use of resonant frequencies in connection with molding processes is not limited to the demolding steps. Resonant frequencies may be used in a substantially similar manner to improve the spreading and dispersion of liquid edible materials initially deposited in the mold tray cavities. This has found utility in depositing liquid chocolate, so that it is distributed around solid inclusions deposited in the mold cavities. This assists in deaerating the liquid chocolate before it is solidified and assists in distributing the liquid material into the cavities.

For example, after a mold is filled with liquid chocolate at depositing station 230, but before the chocolate has solidified at cooling station 240, an energy applicator applies energy at 75 to 125 percent of the predetermined resonant frequency of the filled mold tray for a set period of time until a completely deaerated and dispersed state is achieved.

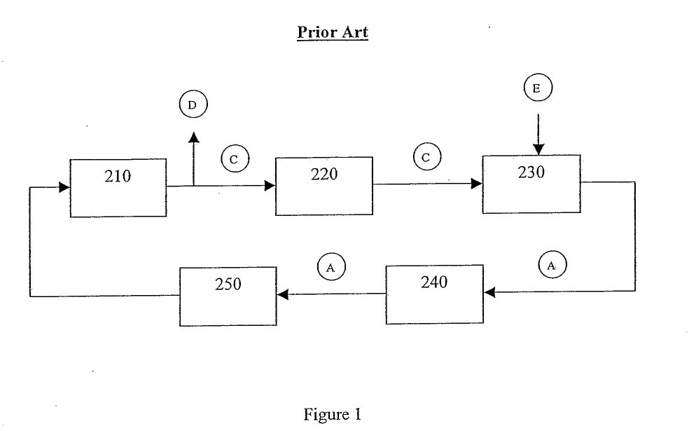

The processes and apparatuses according to the invention can be used to detect when a mold tray is empty. For example, an excitation energy at or near a predetermined resonant frequency for the empty mold tray may be applied, and from a comparison of the response of the mold tray with a predetermined peak response, it may be determined if the mold tray is in fact empty. This technique may be used in a conventional molding/demolding line, for example in place of mold detector 210 shown in FIG. 1.

### EXAMPLE 1

A polycarbonate mold was provided having overall dimensions 650 mm×285 mm having 144 cavities, each cavity having a depth of 9.4 mm and length and width dimension of 28.5 mm. Such a mold has been used to form Dove Promises® molded chocolate pieces.

The resonance characteristics of the tray were measured prior to use on the line, and it was determined that the mold tray had a resonant frequency of 270.26 Hz when empty and 228.52 Hz when full of solid chocolate. The measurement was made by exciting a sample tray utilizing a frequency generator available from Larson Davis, Provo, Utah, and a generic horn driver (Model 1270-35 Wb High Frequency Driver). The resulting vibration was measured using an accelerometer manufactured by Entran Sensors and Electronics, Fairfield, N.J.

In operation, the tray cavities are filled with chocolate, which is solidified. The mold tray is inverted over a demolding belt using conventional demolding equipment. The mold tray is transported to the demolding area, and when the edge of the mold is detected, the online frequency generator delivers initial acoustic energy through an acoustic horn at 80 percent of the previously determined resonant frequency, i.e. at around 180 Hz. The acoustic horn is placed very close to the back of the tray, within about ½ inch. Concurrently, the online vibration monitor, a laser vibrometer available from Polytec, Inc., Auburn, Mass., directs a feedback signal proportional to the amplitude of the vibration to a controller.

Beginning with the aforesaid initial application of energy at about 80 percent of the empirical resonant frequency of the filled mold tray, the applied energy is then ramped upwards in frequency until the response actually observed in the mold tray reaches a value indicating resonance. Using an overdamped control scheme, as the maximum amplitude is approached, the rate of increase of the frequency applied by the energy applicator is slowed, until an amplitude threshold is achieved. Thereafter, as pieces fall out of the tray, and the resonant frequency rises in a direction toward the resonant frequency of the empty tray, the frequency is gradually increased thereafter to keep the frequency just above the observed resonant frequency until all of the pieces are demolded. Amplitude remains in a similar range, even as the resonant frequency of the tray changes as it empties. The entire demolding process takes place in a few seconds, a typical line processing 10-30 molds per minute.

We claim:

1. An apparatus for molding or demolding comprising:
a mold tray having a plurality of mold cavities and having a resonant frequency;
an energy applicator operatively connected to the mold tray for applying energy to the mold tray at about 75 percent to about 125 percent of the resonant frequency of the mold tray.

2. The apparatus of claim 1, further comprising:
a measurement unit operatively connected to the mold tray for measuring a response of the mold tray to the energy applied to the mold tray; and
a controller for modifying the frequency of the energy applied to the mold tray responsive to a feedback signal from the measurement unit.

3. The apparatus of claim 2, wherein the mold tray has a defined resonant frequency when empty, and said measurement unit generates a feedback signal at the resonant frequency when empty to turn off the energy applicator.

4. The apparatus of claim 1, further comprising:
a depositor with a liquid edible starting material conduit directing liquid edible starting material to the mold cavities;
a cooling area where solidified edible pieces are formed in the mold tray; and
a conveyor having a movable surface for receiving solidified edible pieces demolded from the mold tray.

5. The apparatus of claim 1, wherein the mold tray has a resonant frequency in a range of about 150 Hz to about 220 Hz when filled, in a range of about 230 Hz to 300 Hz when empty, and the energy applicator is an acoustic or mechanical device having a frequency in the range of about 120 Hz to about 360 Hz.

6. A method for demolding molded pieces from a mold comprising the steps of:
(a) exciting a mold tray at 75 to 125 percent of a resonant frequency of the mold tray; and
(b) demolding the molded pieces.

7. The method according to claim 6, wherein the molded pieces are demolded by inverting the mold tray so that the molded pieces fall out.

8. The method according to claim 6, wherein the molded pieces are edible molded pieces.

9. A method for demolding a molded product from a filled mold tray comprising the steps of:
(a) applying energy to a mold tray at a frequency less than a predetermined resonant frequency of the mold tray when filled;
(b) determining a response of the mold tray and generating a signal corresponding thereto;
(c) directing the signal to a control system for controlling energy applied to the mold tray;
(d) applying energy according to the signal to cause the mold tray to vibrate at a resonant frequency of the mold tray; and
(e) removing the molded products from the mold tray.

10. The method according to claim 9, wherein after step (b), energy is applied at a frequency to maintain resonance in the mold tray during the course of demolding.

11. A method of producing a molded product in a mold tray comprising the steps of:
(a) depositing liquid edible material into cavities arranged in a mold tray; and
(b) applying energy to the mold tray at 75 percent to 125 percent of a resonant frequency of the mold tray to assist in the dispersion of the liquid material in the cavities.

12. A method for determining an empty state of a mold tray comprising the steps of:
(a) applying an excitation energy to the mold tray;
(b) measuring a response produced in the mold tray by the excitation energy; and
(c) determining if the measured response corresponds to a peak response at a predetermined resonant frequency of the mold tray when empty to determine the empty state.
